(19) United States
(12) Patent Application Publication
(10) Pub. No.: US 2021/0188451 A1
(43) Pub. Date: Jun. 24, 2021

(54) METHOD AND APPARATUS FOR POWER SUPPLY

(71) Applicant: SZ DJI TECHNOLOGY CO., LTD., Shenzhen (CN)

(72) Inventors: Tong WANG, Shenzhen (CN); Tao LIN, Shenzhen (CN)

(21) Appl. No.: 17/173,110

(22) Filed: Feb. 10, 2021

Related U.S. Application Data
(63) Continuation of application No. PCT/CN2018/100829, filed on Aug. 16, 2018.

(51) Int. Cl. B64D 27/00; H02J 7/00; G06F 1/26; B64C 39/02

(52) U.S. Cl. CPC B64D 27/00; H02J 7/0063; G06F 2213/0042; B64C 39/024; G06F 1/26

(57) ABSTRACT

A power supply method includes when detecting that a host apparatus is connected to an external apparatus via a connector, determining a maximum voltage value supported by the external apparatus, and selecting a first power supply circuit or a second power supply circuit to supply power to the external apparatus according to the maximum voltage value. A first power supply voltage value of the first power supply circuit is greater than a second power supply voltage value of the second power supply circuit.

### CROSS-REFERENCE TO RELATED APPLICATION

This application is a continuation of International Application No. PCT/CN2018/100829, filed Aug. 16, 2018, the entire content of which is incorporated herein by reference.

### TECHNICAL FIELD

The present disclosure generally relates to the electronic technology field and, more particularly, to a method and an apparatus for power supply.

### BACKGROUND

Currently, universal serial bus (USB) is a standard for external bus. A USB connector based on this standard can be used as a communication apparatus and a power supply apparatus. The USB connector is also referred to as a USB interface, which is arranged in various apparatuses. When using the USB connector to supply power, the apparatus can provide a standard voltage of 5 V, and a maximum current of 2 A. Therefore, the apparatus can only provide a maximum power of 10 W. When an external apparatus is connected to the apparatus through the USB interface and needs a larger power, the transmission power of the USB interface needs to be increased.

Currently, a method of increasing the transmission power includes various USB fast charging protocols. However, these protocols are implemented based on physical level and need specific support of a bottom-level chip, which results in a complex power source circuit design.

### SUMMARY

Embodiments of the present disclosure provide a power supply method. The method includes when detecting that a host apparatus is connected to an external apparatus via a connector, determining a maximum voltage value supported by the external apparatus, and selecting a first power supply circuit or a second power supply circuit to supply power to the external apparatus according to the maximum voltage value. A first power supply voltage value of the first power supply circuit is greater than a second power supply voltage value of the second power supply circuit.

Embodiments of the present disclosure provide a power supply apparatus, including a processor and a storage device. The storage device stores program instructions that, when being executed by the processor, cause the processor to when detecting that a host apparatus is connected to an external apparatus via a connector, determine a maximum voltage value supported by the external apparatus, and select a first power supply circuit or a second power supply circuit to supply power to the external apparatus according to the maximum voltage value. A first power supply voltage value of the first power supply circuit is greater than a second power supply voltage value of the second power supply circuit.

Embodiments of the present disclosure provide an unmanned aerial vehicle (UAV), including a vehicle body, a propulsion system, a processor, and a storage device. The vehicle body includes a power supply circuit. The power supply circuit includes a first power supply circuit and a second power supply circuit. The propulsion system is arranged at the vehicle body and configured to provide power for flight. The storage device stores program instructions that, when being executed by the processor, cause the processor to when detecting that a host apparatus is connected to an external apparatus via a connector, determine a maximum voltage value supported by the external apparatus, and select a first power supply circuit or a second power supply circuit to supply power to the external apparatus according to the maximum voltage value. A first power supply voltage value of the first power supply circuit is greater than a second power supply voltage value of the second power supply circuit.

### BRIEF DESCRIPTION OF THE DRAWINGS

FIG. 1 is a schematic structural diagram of a host apparatus according to some embodiments of the present disclosure.

FIG. 2 is a schematic structural diagram of another host apparatus according to some embodiments of the present disclosure.

FIG. 3 is a schematic structural diagram of a power supply system according to some embodiments of the present disclosure.

FIG. 4 is a schematic flowchart of a power supply method according to some embodiments of the present disclosure.

FIG. 5 is a schematic flowchart of another power supply method according to some embodiments of the present disclosure.

FIG. 6 is a schematic structural diagram of a power supply apparatus according to some embodiments of the present disclosure.

FIG. 7 is a schematic structural diagram of an unmanned aerial vehicle (UAV) according to some embodiments of the present disclosure.

### DETAILED DESCRIPTION OF THE EMBODIMENTS

The technical solutions of the present disclosure are described in detail in connection with the accompanying drawings of the present disclosure. Described embodiments are merely some embodiments of the present disclosure, not all embodiments. Based on embodiments of the present disclosure, all other embodiments obtained by those of ordinary skill in the art without creative efforts are within the scope of the present disclosure.

The present disclosure provides a power supply method. Different power supply powers may be provided to an external apparatus through a connector. The power supply method of the present disclosure may be based on a standard communication protocol paper of the connector, and belong to a scope of an application layer. A processor of any connector may implement the method without introducing external cost. In some embodiments, the power supply method needs to output high power, which needs to be supported by a bottom layer chip, for example, designing a complex power supply circuit. However, in embodiments of the present disclosure, the power supply power may be increased by a manner of increasing a power supply voltage. To ensure the safety of the power supply, in some embodiments, a maximum power supply voltage that the external apparats can support may be obtained through a manner of a communication protocol.

In some embodiments, the connector may include an apparatus that may be configured as a communication interface or a power supply interface between apparatuses, for example, a universal serial bus (USB) interface. When the USB interface supplies power, a standard USB communication protocol may be used. By using the USB interface as the connector and using the power supply method of embodiments of the present disclosure, the maximum power supply power that may be provided to the external apparatus theoretically may range from 60 W to 90 W, which may be determined according to the maximum voltage and rated power supported by the external apparatus.

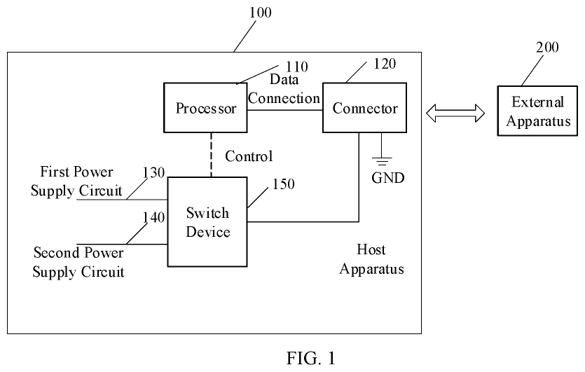

The power supply method provided by embodiments of the present disclosure may be applied in a host apparatus. The host apparatus may include a power supply circuit. The power supply circuit may include a first power supply circuit and a second power supply circuit, but is not limited to these two power supply circuits. A power supply voltage value of the first power supply circuit, also referred to as a “first power supply voltage value,” may be greater than a power supply voltage value of the second power supply circuit, also referred to as a “second power supply voltage value.” The first power supply circuit and the second power supply circuit may be connected to a same power source and may use different circuit designs to provide different power supply voltages. FIG. 1 is a schematic structural diagram of the host apparatus 100 according to some embodiments of the present disclosure. As shown in FIG. 1, the host apparatus 100 includes a processor 110, a connector 120, a first power supply circuit 130, a second power supply circuit 140, and a switch device 150. The processor 110 and the connector 120 establish a data connection. The first power supply circuit 140 and the second power supply circuit 140 are connected to the connector 120 through the switch device 150. The processor 110 is connected to the switch device 150 to control the switch device 150 to select the first power supply circuit 130 or the second power supply circuit 140 to supply power to the external apparatus. That is, the switch device 150 may be controlled to select the first power supply circuit 130 or the second power supply circuit 140 to be connected to the connector 120.

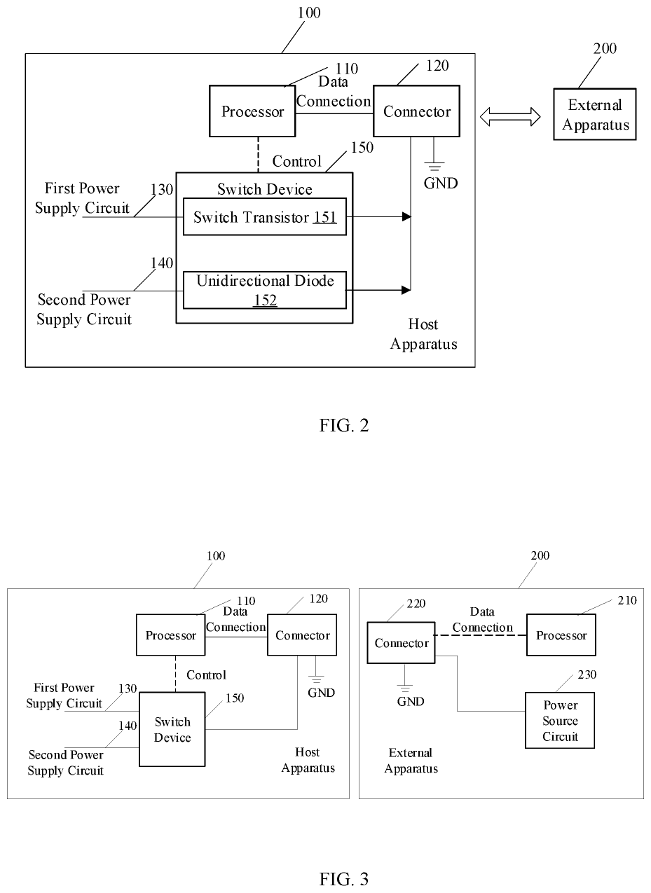

FIG. 2 is a schematic structural diagram of another host apparatus according to some embodiments of the present disclosure. As shown in FIG. 2, the switch device 150 includes a switch transistor 151 and a unidirectional diode 152. The switch transistor 151 is connected to the first power supply circuit 130. The unidirectional diode 152 is connected to the second power supply circuit 140. The first power supply circuit 130 or the second power supply circuit 140 is selected via the switch device 150 to supply power to the external apparatus according to a value of the maximum voltage (“maximum voltage value”). For example, when the maximum voltage value is in a high voltage range, the switch transistor 151 may be controlled to be on and the unidirectional diode 152 may be controlled to be off, such that the first power supply circuit 130 may supply power to the external apparatus. On the other hand, when the maximum voltage value is in a low voltage range, the switch transistor 151 may be controlled to be off and the unidirectional diode 152 may be controlled to be on, such that the second power supply circuit 140 may supply power to the external apparatus.

FIG. 3 is a schematic structural diagram of a power supply system according to some embodiments of the present disclosure. As shown in FIG. 3, the power supply system includes the host apparatus 100 and the external apparatus 200. The structural diagram of the host apparatus is as shown in FIG. 1 or FIG. 2, which is not detailed here. The external apparatus 200 includes a processor 210, a connector 220, and a power source circuit 230. The processor 210 and the connector 220 establish a data connection. The power source circuit 230 is connected to the connector 220 and receives the power supply power provided by the host apparatus 100 via the connector 120.

As shown in FIG. 3, the host apparatus 100 and the external apparatus 200 form a communication connection via the connector 120 and the connector 220 to determine the maximum voltage value supported by the external apparatus 200. For example, the host apparatus and the external apparatus may establish the communication connection in a handshake manner. When the external apparatus is connected to the host apparatus, the host apparatus may use the second power supply circuit to supply power to the external apparatus. The power supply voltage of the second power supply circuit may be able to start the processor of the external apparatus, but may not be able to start operations of devices of the external apparatus. As such, the communication connection may be ensured to be established between the host apparatus and the external apparatus.

In some embodiments, the host apparatus may include an unmanned aerial vehicle (UAV), a flying robot, etc. The external apparatus may include accessories of the UAV and the flying robot, for example, a searchlight, a spare propeller, etc. The host apparatus may supply power to these external apparatuses by the power supply method described in embodiments of the present disclosure, and provide the power needed by these external apparatuses when determining the maximum voltage supported by the external apparatus via the communication connection.

Embodiments of the present disclosure provide the method and the apparatus for power supply, which are configured to supply power to the external apparatuses with various power requirements and ensure the safety of the power supply, which are described in detail below.

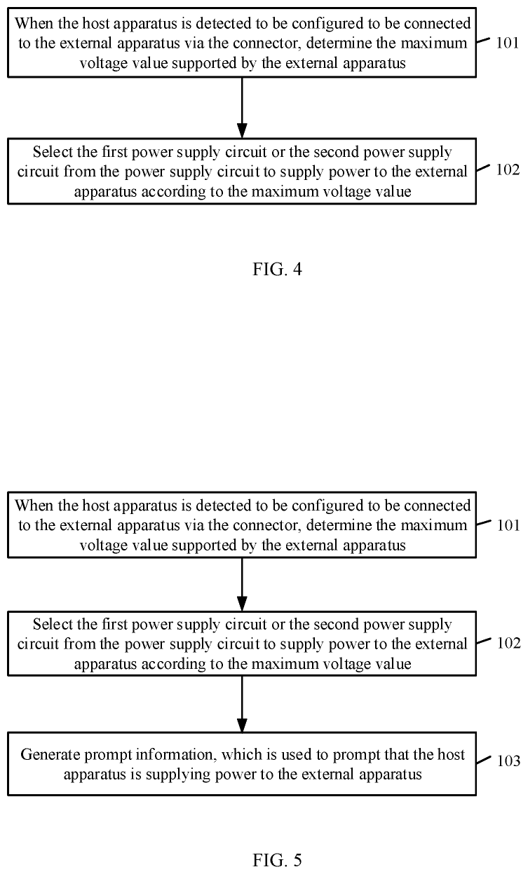

FIG. 4 is a schematic flowchart of the power supply method according to some embodiments of the present disclosure. The power supply method described in embodiments of the present disclosure may be applied in the host apparatus. The host apparatus may include a power supply circuit. The power supply circuit may include a first power supply circuit and a second power supply circuit. The method includes the following processes.

At 101, when the host apparatus is detected to be configured to be connected to the external apparatus via the connector, the host apparatus determines the maximum voltage value supported by the external apparatus.

In some embodiments, the host apparatus determining the maximum voltage value supported by the external apparatus may include the following processes. When the external apparatus is successfully connected, the host apparatus may obtain apparatus information of the external apparatus. According to the apparatus information, the maximum voltage value supported by the external apparatus may be determined.

For example, the apparatus information may include manufacturer identification and product identification of the external apparatus. The host apparatus may obtain the maximum voltage value supported by the external apparatus according to the manufacturer identification and the product identification. For example, a correspondence table between the apparatus information and the supported maximum voltage value may be stored in the processor of the host apparatus. The host apparatus may determine the maximum voltage value supported by the external apparatus by inquiring the correspondence table. As another example, the host apparatus may transmit the apparatus information to another apparatus, such as a server or a remote apparatus to inquire the maximum voltage value supported by the external apparatus.

In some embodiments, the host apparatus determining the maximum voltage value supported by the external apparatus includes the following processes. The host apparatus may transmit a request message to the external apparatus. The request message may be used to request the maximum voltage value supported by the external apparatus. The host apparatus may receive a response message returned by the external apparatus. The response message may carry the maximum voltage value.

In some embodiments, when the host apparatus and the external apparatus are connected via the connector, the host apparatus may use the second power supply circuit to supply power to the external apparatus. The power supply voltage of the second power supply circuit may start the processor of the external apparatus. The power supply voltage of the second power supply circuit may include a standard voltage of the connector and may at least start the processor of the external apparatus to cause the host apparatus to be communicatively connected to the external apparatus. Whether the power supply voltage of the second power supply circuit can start operation or work of other devices of the external apparatus may be determined according to the rated voltage and/or the rated current of the external apparatus.

For example, the external apparatus may include a searchlight, the host apparatus may include the UAV, and the searchlight is connected to the UAV via the connector. Since the searchlight may need a power supply with a large power to be in operation status, when the UAV uses the second power supply circuit to supply power to the searchlight, only the processor of the searchlight may be started, and a lighting device of the searchlight may not operate. As such, since the power supply voltage of the second power supply circuit is the standard voltage, the safety of the power supply may be ensured. Meanwhile, the maximum voltage value supported by the external apparatus may be obtained to determine the power supply circuit to supply power to the external apparatus.

At 102, the host apparatus selects the first power supply circuit or the second power supply circuit from the power supply circuit to supply power to the external apparatus according to the maximum voltage value.

In some embodiments, the power supply voltage of the first power supply circuit is greater than the power supply voltage of the second power supply circuit.

In some embodiments, the host apparatus selecting the first power supply circuit or the second power supply circuit from the power supply circuit to supply power to the external apparatus according to the maximum voltage value may include the following processes. When the maximum voltage value is in the high voltage range, the host apparatus may switch to the first power supply circuit to supply power to the external apparatus. The high voltage range may include a range with all voltage values greater than the standard power supply voltage value. When the maximum voltage value is in the low voltage range, the host apparatus may continue to use the second power supply circuit to supply power to the external apparatus. The low voltage range may include a range with all voltage values smaller than or equal to the standard power supply voltage value.

In some embodiments, the host apparatus selecting the first power supply circuit or the second power supply circuit from the power supply circuit to supply power to the external apparatus according to the maximum voltage value may include the following process. The host apparatus may control the switch device to select the first power supply circuit or the second power supply circuit to supply power to the external apparatus according to the maximum voltage value.

As shown in FIG. 2, the switch device 150 includes the switch transistor 151 and the unidirectional diode 152. The switch transistor 151 is connected to the first power supply circuit 130. The unidirectional diode 152 is connected to the second power supply circuit 140. According to the maximum voltage value, controlling the switch device to select the first power supply circuit or the second power supply circuit to supply power to the external apparatus may include the following processes. When the maximum voltage value is in the high voltage range, the switch transistor may be controlled to be on, the unidirectional diode may be controlled to be off, and the first power supply circuit may supply power to the external apparatus. When the maximum voltage value is in the low voltage range, the switch transistor may be controlled to be off, the unidirectional diode may be controlled to be on, and the second power supply circuit may supply power to the external apparatus.

In some embodiments, the high voltage range may include the range with all the voltage values greater than the standard power supply voltage value. The low voltage range may include the range with all the voltage values smaller than or equal to the standard power supply voltage value. For example, the standard voltage value of a USB interface may be 5 V, thus, the standard power supply voltage value of the host apparatus may be 5 V. The power supply voltage of the second power supply circuit may be smaller than or equal to 5 V (such as 5 V). As such, the processor of the external apparatus may be ensured to be started. The power supply voltage of the first power supply circuit may be greater than 5 V, for example, 17 V. In some embodiments, the first power supply circuit and the second power supply circuit may include power supply voltages each of a plurality of voltage values. The power supply voltage of the first power supply circuit or the power supply voltage of the second power supply circuit may be further determined according to the maximum voltage value and the rated power supported by the external apparatus.

In embodiments of the present disclosure, the method may include supplying power to the external apparatuses of the different power requirements according to the maximum voltage values supported by the external apparatuses. The power supply power may be ensured, while the safety of the power supply may be ensured, which may avoid the external apparatus, which cannot support a large power, from being damaged by the large power provided by the host apparatus.

FIG. 5 is a schematic flowchart of another power supply method according to some embodiments of the present disclosure. Compared to the power supply method shown in FIG. 4, the power supply method shown in FIG. 5 further includes the following process.

At 103, the host apparatus generates prompt information, which is used to prompt that the host apparatus is supplying power to the external apparatus.

The prompt information may be used to prompt that the host apparatus is supplying power to the external apparatus. The provided power supply voltage may cause the external apparatus to be in the operation status and satisfy the power requirements of the various external apparatuses.

In some embodiments, the host apparatus may output the prompt information or transmit the prompt information to the remote apparatus or a display apparatus. The prompt information may be output by the remote apparatus or the display apparatus.

In some embodiments, the prompt information may be used to control the indicator of the power supply status to be in a flashing status.

As such, the power supply method shown in FIG. 5 can allow the user to can be aware of the power supply situation of the external apparatus in time and can inform the user whether the host apparatus and the external apparatus are matched, for example, whether the host apparatus can provide electrical power satisfying the power requirements of the external apparatus.

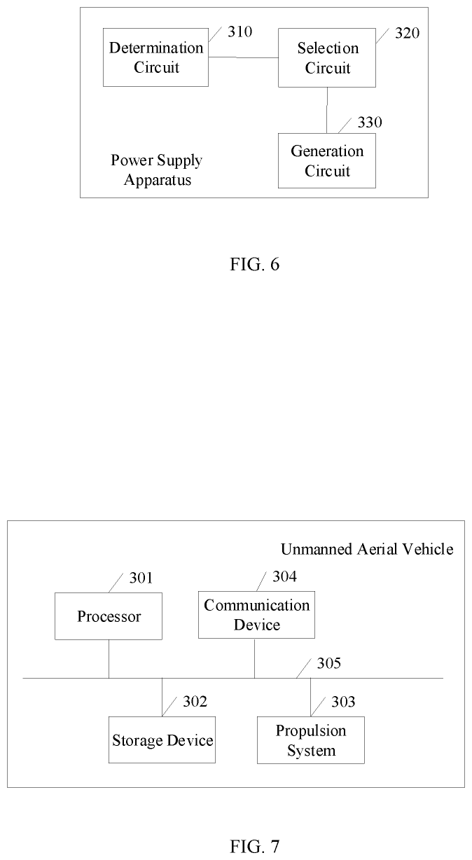

FIG. 6 is a schematic structural diagram of a power supply apparatus according to some embodiments of the present disclosure. The power supply apparatus of embodiments of the present disclosure includes the power supply circuit. The power supply circuit includes the first power supply circuit and the second power supply circuit. The power supply apparatus includes a determination circuit 310 and a selection circuit 320.

The determination circuit 310 may be configured to determine the maximum voltage value supported by the external apparatus when detecting that the host apparatus is configured to be connected to the external apparatus via the connector.

The selection circuit 320 may be configured to select the first power supply circuit or the second power supply circuit from the power supply circuit to supply power to the external apparatus according to the maximum voltage value.

The first power supply voltage value of the first power supply circuit is greater than the second power supply voltage value of the second power supply circuit.

In some embodiments, the selection circuit 320 may be further configured to use the second power supply circuit to supply power to the external apparatus when detecting that the connector is connected to the external apparatus. The second power supply voltage of the second power supply circuit may be able to start the processor of the external apparatus.

In some embodiments, the selection circuit 320 selecting the first power supply circuit or the second power supply circuit from the power supply circuit to supply power to the external apparatus according to the maximum voltage value includes the following processes. When the maximum voltage value is in the high voltage range, the host apparatus may switch to the first power supply circuit to supply power to the external apparatus. The high voltage range may include the range with all the voltage values greater than the standard power supply voltage value. When the maximum voltage value is in the low voltage range, the host apparatus may continue to use the second power supply circuit to supply power to the external apparatus. The lower voltage range may include the range with all the voltage values smaller than or equal to the standard power supply voltage value.

In some embodiments, the selection circuit 320 selecting the first power supply circuit or the second power supply circuit from the power supply circuit to supply power to the external apparatus according to the maximum voltage value includes the following process. The host apparatus may control the switch device to select the first power supply circuit or the second power supply circuit to supply power to the external apparatus according to the maximum voltage value.

In some embodiments, the switch device includes the switch transistor and the unidirectional diode. The switch transistor may be connected to the first power supply circuit. The unidirectional diode may be connected to the second power supply circuit. The selection circuit 320 controlling the switch device to select the first power supply circuit or the second power supply circuit to supply power to the external apparatus according to the maximum voltage value may include the following processes. When the maximum voltage value is in the high voltage range, the selection circuit 320 may control the switch transistor to be on and the unidirectional diode to be off to supply power to the external apparatus via the first power supply circuit. When the maximum voltage value is in the low voltage range, the selection circuit 320 may control the switch transistor to be off and the unidirectional diode to be on to supply power to the external apparatus via the second power supply circuit.

In some embodiments, the determination circuit 310 determining the maximum voltage value supported by the external apparatus includes the following processes. When the external apparatus is successfully connected, the determination circuit 310 may obtain the apparatus information of the external apparatus and determine the maximum voltage value supported by the external apparatus according to the apparatus information.

The apparatus information may include the manufacturer identification and the product identification of the external apparatus.

In some embodiments, the determination circuit 310 determining the maximum voltage value supported by the external apparatus may include the following processes. The determination circuit 310 may transmit the request message to the external apparatus. The request message is used to request the maximum voltage value supported by the external apparatus. The determination circuit 310 may receive the response message returned by the external apparatus. The response message may carry the maximum voltage value.

In some embodiments, the power supply apparatus may further include a generation circuit 330. The generation circuit 330 may be configured to generate the prompt information. The prompt information may be used to prompt that the host apparatus is supplying power to the external apparatus.

In some embodiments, the power supply apparatus may further include an output circuit. The output circuit may be configured to output the prompt information. In some other embodiments, the power supply apparatus may further include a transmission circuit. the transmission circuit may be configured to transmit the prompt information to the remote apparatus or the display apparatus to output the prompt information by the remote apparatus or the display apparatus.

In some embodiments, the prompt information may be used to control the indicator of the power supply status to be in the flashing status.

In some embodiments, the connector may include a USB interface.

In some embodiments, the power supply apparatus may supply power to the external apparatuses with different power requirements according to the maximum voltage values supported by the external apparatuses. While the power supply power is ensured, the safety of the power supply may be ensured, which may avoid the external apparatus, which cannot support the large power, from being damaged by the large power provided by the host apparatus.

FIG. 7 is a schematic structural diagram of an unmanned aerial vehicle according to some embodiments of the present disclosure. The UAV is described as an example of the power supply apparatus. The UAV includes the power supply circuit. The power supply circuit includes the first power supply circuit and the second power supply circuit. As shown in FIG. 7, the UAV further includes at least a processor 301, for example, a CPU, at least a storage device 302, a propulsion system 303, and a communication device 304. The processor 301, the storage device 302, the propulsion system 303, and the communication device 304 are connected via a bus 305.

The propulsion system 303 may be configured to provide power for the flight of the UAV. The communication device 304 may be configured to receive and transmit a message, for example, receive and transmit the prompt information.

The storage device 302 may be configured to store an instruction. The processor 301 may be configured to call program codes stored in the storage device 302.

In some embodiments, the processor 301 may be configured to call the program codes stored in the storage device 302 to determine the maximum voltage value supported by the external apparatus when detecting that the host apparatus is configured to be connected to the external apparatus via the connector, and select the first power supply circuit or the second power supply circuit from the power supply circuit to supply power to the external apparatus according to the maximum voltage value. The first power supply voltage value of the first power supply circuit may be greater than the second power supply voltage value of the second power supply circuit.

In some embodiments, the processor 301 may be configured to call the program codes stored in the storage device 302 to use the second power supply circuit to supply power to the external apparatus when detecting that the connector is connected to the external apparatus. The second power supply voltage of the second power supply circuit may be able to start the processor of the external apparatus.

In some embodiments, the processor 301 may be configured to call the program codes stored in the storage device 302 to select the first power supply circuit or the second power supply circuit from the power supply circuit to supply power to the external apparatus according to the maximum voltage value, which includes the following processes.

When the maximum voltage value is in the high voltage range, the processor 301 may be configured to call the program codes stored in the storage device 302 to switch to the first power supply circuit to supply power to the external apparatus. The high voltage range may include the range with all the voltage values greater than the standard power supply voltage value.

When the maximum voltage value is in the low voltage range, the processor 301 may be configured to call the program codes stored in the storage device 302 to continue to use the second power supply circuit to supply power to the external apparatus. The voltage value of the low voltage range may include the range with all the voltage values smaller than or equal to the standard power supply voltage value.

In some embodiments, the processor 301 may be configured to call the program codes stored in the storage device 302 to select the first power supply circuit or the second power supply circuit from the power supply circuit to supply power to the external apparatus according to the maximum voltage value, which includes the following process.

The processor 301 may be configured to call the program codes stored in the storage device 302 to control the switch device to select the first power supply circuit or the second power supply circuit to supply power to the external apparatus according to the maximum voltage value.

In some embodiments, the switch device includes the switch transistor and the unidirectional diode. The switch transistor is connected to the first power supply circuit. The unidirectional diode is connected to the second power supply circuit. The processor 301 may be configured to call the program codes stored in the storage device 302 to control the switch device to select the first power supply circuit or the second power supply circuit to supply power to the external apparatus according to the maximum voltage value, which includes the following processes.

When the maximum voltage value is in the highest voltage range, the processor 301 may call the program codes stored in the storage device 302 to control the switch transistor to be on and the unidirectional diode to be off to supply power to the external apparatus via the first power supply circuit.

When the maximum voltage value is in the low voltage range, the processor 301 may call the program codes stored in the storage device 302 to control the switch transistor to be off and the unidirectional diode to be on to supply power to the external apparatus via the second power supply circuit.

In some embodiments, the processor 301 may be configured to call the program codes stored in the storage device 302 to determine the maximum voltage value supported by the external apparatus, which includes the following processes.

When the external apparatus is successfully connected, the processor 301 may call the program codes stored in the storage device 302 to obtain the apparatus information of the external apparatus and determine the maximum voltage value supported by the external apparatus according to the apparatus information.

The apparatus information may include the manufacturer identification and the product identification of the external apparatus.

In some embodiments, the processor 301 may be configured to call the program codes stored in the storage device 302 to determine the maximum voltage value supported by the external apparatus, which includes the following processes.

The processor 301 may be configured to call the program codes stored in the storage device 302 to transmit the request message to the external apparatus and receive the response message returned by the external apparatus. The request message may be used to request the maximum voltage value supported by the external apparatus. The response message may carry the maximum voltage value.

In some embodiments, the processor 301 may be configured to call the program codes stored in the storage device 302 to generate the prompt information. The prompt information may be used to prompt that the host apparatus is supplying power to the external apparatus.

In some embodiments, the processor 301 may be configured to call the program codes stored in the storage device 302 to output the prompt information or transmit the prompt information to the remote apparatus or the display apparatus to output the prompt information by the remote apparatus or the display apparatus.

In some embodiments, the prompt information may be used to control the indicator of the power supply status to be in the flashing status.

In some embodiments, the connector may include the USB interface.

To simplify the description, method embodiments of the present disclosure are described in a series of action combinations. However, those skilled in the art should know that the present disclosure is not limited by the described action sequence, because some processes may use another sequence or be performed simultaneously according to the present disclosure. Those skilled in the art should also know that the embodiments described in the specification are some embodiments. The actions or circuits related to embodiments may not be necessary for the present disclosure.

Those of ordinary skill in the art may understand that all or some of the processes in the various methods of embodiments of the present disclosure may be completed by a program instructing relevant hardware. The program may be stored in a computer-readable storage medium. The storage medium may include a flash disk, a read-only memory (ROM), a random access memory (RAM), a magnetic disk, an optical disk, etc.

Only some embodiments of the present disclosure are described above, which may not be used to limit the scope of the present disclosure. Those of ordinary skill in the art can understand all or some of the processes of implementing the above-mentioned embodiments and may make equivalent changes according to the claims of the present invention. Those equivalent changes are still within the scope of the present disclosure.

What is claimed is:

1. A power supply method comprising:
in response to detecting that a host apparatus is connected to an external apparatus via a connector, determining a maximum voltage value supported by the external apparatus; and
selecting a first power supply circuit or a second power supply circuit to supply power to the external apparatus according to the maximum voltage value, a first power supply voltage value of the first power supply circuit being greater than a second power supply voltage value of the second power supply circuit.

2. The method of claim 1, further comprising, in response to detecting that the connector is connected to the external apparatus:
supplying power to the external apparatus using the second power supply circuit, the second power supply voltage value being greater than a voltage value required to start a processor of the external apparatus.

3. The method of claim 1, wherein selecting the first power supply circuit or the second power supply circuit includes:
in response to the maximum voltage value being in a high voltage range, selecting the first power supply circuit to supply power to the external apparatus, the high voltage range including a voltage range greater than a standard power supply voltage value of the connector; or
in response to the maximum voltage value being in a low voltage range, selecting the second power supply circuit to supply power to the external apparatus, the low voltage range including a voltage range smaller than or equal to the standard power supply voltage value.

4. The method of claim 1, wherein selecting the first power supply circuit or the second power supply circuit includes:
controlling a switch device to select the first power supply circuit or the second power supply circuit to supply power to the external apparatus according to the maximum voltage value.

5. The method of claim 4, wherein:
the switch device includes:
a switch transistor coupled to the first power supply circuit; and
a unidirectional diode coupled to the second power supply circuit; and
controlling the switch device to select the first power supply circuit or the second power supply circuit includes:
in response to the maximum voltage value being in a high voltage range, controlling the switch transistor to be on and the unidirectional diode to be off, the high voltage range including a voltage range greater than a standard power supply voltage value of the connector; and
in response to the maximum voltage value being in a low voltage range, controlling the switch transistor to be off and the unidirectional diode to be on, the low voltage range including a voltage range smaller than or equal to the standard power supply voltage value.

6. The method of claim 1, wherein determining the maximum voltage value supported by the external apparatus includes:
in response to the external apparatus being successfully connected, obtaining apparatus information of the external apparatus; and
determining the maximum voltage value supported by the external apparatus according to the apparatus information.

7. The method of claim 6, wherein the apparatus information includes a manufacturer identification and a product identification of the external apparatus.

8. The method of claim 1, wherein determining the maximum voltage value supported by the external apparatus includes:
transmitting a request message to the external apparatus, the request message being used to request the maximum voltage value supported by the external apparatus; and
receiving a response message returned by the external apparatus, the response message carrying the maximum voltage value.

9. The method of claim 1, further comprising:
generating prompt information, the prompt information being used to prompt that the host apparatus is supplying power to the external apparatus.

10. The method of claim 9, further comprising:
outputting the prompt information; or
transmitting the prompt information to a remote apparatus or a display apparatus to output the prompt information by the remote apparatus or the display apparatus.

11. The method of claim 10, wherein the prompt information is used to control an indicator of power supply status to be in a flashing status.

12. The method of claim 1, wherein the connector includes a universal serial bus (USB) interface.

13. A power supply apparatus comprising:
a processor; and
a storage device storing program instructions that, when being executed by the processor, cause the processor to:
in response to detecting that a host apparatus is connected to an external apparatus via a connector, determine a maximum voltage value supported by the external apparatus, the host apparatus including a first power supply circuit and a second power supply circuit; and
select the first power supply circuit or the second power supply circuit to supply power to the external apparatus according to the maximum voltage value, a first power supply voltage value of the first power supply circuit being greater than a second power supply voltage value of the second power supply circuit.

14. The apparatus of claim 13, wherein the program instructions further cause the processor to:
in response to detecting that the connector is connected to the external apparatus, control the second power supply circuit to supply power to the external apparatus, the second power supply voltage value being greater than a voltage value required to start a processor of the external apparatus.

15. The apparatus of claim 13, wherein the program instructions further cause the processor to:
in response to the maximum voltage value being in a high voltage range, select the first power supply circuit to supply power to the external apparatus, the high voltage range including a voltage range greater than a standard power supply voltage value of the connector; or
in response to the maximum voltage value being in a low voltage range, select the second power supply circuit to supply power to the external apparatus, the low voltage range including a voltage range smaller than or equal to the standard power supply voltage value.

16. The apparatus of claim 13, wherein the program instructions further cause the processor to:
in response to the external apparatus being successfully connected, obtain apparatus information of the external apparatus; and
determine the maximum voltage value supported by the external apparatus according to the apparatus information.

17. The apparatus of claim 13, wherein the program instructions further cause the processor to:
transmit a request message to the external apparatus, the request message being used to request the maximum voltage value supported by the external apparatus; and
receive a response message returned by the external apparatus, the response message carrying the maximum voltage value.

18. The apparatus of claim 13, wherein the program instructions further cause the processor to:
generate prompt information, the prompt information being used to prompt that the host apparatus is supplying power to the external apparatus.

19. An unmanned aerial vehicle (UAV) comprising:
a vehicle body, including a power supply circuit, the power supply circuit including a first power supply circuit and a second power supply circuit;
a propulsion system, arranged at the vehicle body and configured to provide power for flight;
a processor; and
a storage device storing program instructions that, when being executed by the processor, cause the processor to:
in response to detecting that a host apparatus is connected to an external apparatus via a connector, determine a maximum voltage value supported by the external apparatus, the host apparatus including a first power supply circuit and a second power supply circuit; and
select the first power supply circuit or the second power supply circuit to supply power to the external apparatus according to the maximum voltage value, a first power supply voltage value of the first power supply circuit being greater than a second power supply voltage value of the second power supply circuit.

20. The UAV of claim 19, wherein the program instructions further cause the processor to:
in response to the maximum voltage value being in a high voltage range, select the first power supply circuit to supply power to the external apparatus, the high voltage range including a voltage range greater than a standard power supply voltage value of the connector; or
in response to the maximum voltage value being in a low voltage range, select the second power supply circuit to supply power to the external apparatus, the low voltage range including a voltage range smaller than or equal to the standard power supply voltage value.
